(19) United States
(12) Patent Application Publication
(10) Pub. No.: US 2016/0310910 A1
(43) Pub. Date: Oct. 27, 2016

(54) PROCESS FOR THE FABRICATION OF A WATER FILTER

(71) Applicant: DSM IP ASSETS B.V., Heerlen (NL)

(72) Inventors: Roman STEPANYAN, Echt (NL); Marko DORSCHU, Echt (NL); Petrus Johannes Lambertus BOONEN, Echt (NL); Filip Stefan Emiel OOSTERLINCK, Echt (NL)

(21) Appl. No.: 15/104,424

(22) PCT Filed: Dec. 11, 2014
(86) PCT No.: PCT/EP2014/077328

§ 371 Date: Jun. 14, 2016

(30) Foreign Application Priority Data
Dec. 20, 2013 (EP) 13198882.6

(51) Int. Cl. B01D 71/56; B32B 5/26; B32B 5/02; B01D 61/14; B01D 67/00

(52) U.S. Cl. CPC B01D 71/56; B01D 61/147; B01D 67/0083; B32B 5/022; B32B 5/26; B01D 2323/08; B01D 2323/12; B01D 2323/39; B32B 2255/02; B32B 2255/26; B32B 2262/0261; B32B 2262/0276; B32B 2307/726; D01D 5/0038

(57) ABSTRACT

The invention relates to a method for the manufacture of a layered membrane construction comprising a) providing a solution comprising a mixture of a polymer A and a polymer B in a weight ratio A/B between 50/50 and 95/05, polymer A having a melting temperature TmA and a polymer B having a melting temperature TmB wherein TmB is below TmA by at least 40° C.; b) applying the solution provided in step a) on a first carrier substrate to form a nanofiber layer on said substrate; c) consolidating the nanofiber layer formed on the substrate by thermal bonding at a temperature between TmB and TmA by means of a temperature and/or pressure cycle thus obtaining the membrane.

The invention relates to a membrane construction and a method for fabricating such a membrane construction and to a filtering device.

Fibrous nonwoven membranes are suitable for use in microfiltration. Microfiltration is widely accepted in industry to remove microorganisms, such as bacteria and viruses, from a fluid stream.

The two most desired features of a liquid microfiltration membrane are high permeability and reliable retention. Naturally, there is a trade-off between these two parameters, and for the same type of membrane, greater retention has historically been achieved by sacrificing permeability of the membrane.

A quantitative measure of microorganism retention by a filtration membrane is customarily expressed as a Log Reduction Value, abbreviated as LRV. LRV is the logarithm of the ratio of the Colony Forming Units (CFU) concentration in the membrane influent solution to that in the membrane effluent solution:

LRV=Log{[CFU]_{influent}/[CFU]_{effluent}} (1)

Another desired feature of a liquid filtration membrane construction is that the initial retention should be maintained during the lifetime, and in particular as a function of the amount of water that passed the membrane.

One disadvantage of the prior art is a rapid decrease of the initial retention for microorganisms resulting in a relatively short lifetime of the membrane. This could be caused by a lack of adhesion between the fibers within the layer of nanofibers, wherefore the combination of water flow and pressure creates channels through the layer of nanofibers.

An object of the present invention is to provide a membrane with a steadier LRV in function of the amount of water passed through the membrane.

According to the invention, this goal is achieved by the method for the manufacture of a layered membrane construction comprising:
a) providing a solution comprising a mixture of a polymer A and a polymer B in a weight ratio A/B between 50/50 and 95/05, polymer A having a melting temperature Tm_{A} and a polymer B having a melting temperature Tm_{B} wherein Tm_{B} is below Tm_{A} by at least 40° C.;
b) applying the solution provided in step a) on a first carrier substrate to form a nanofiber layer on said substrate;
c) consolidating the nanofiber layer formed on the substrate by thermal bonding at a temperature between Tm_{B} and Tm_{A} by means of a temperature and/or pressure cycle thus obtaining the membrane.

An embodiment of the present invention relates to a method for the manufacture of a layered membrane construction comprising polyamide 46 or a copolymer thereof comprising:
a) providing a solution comprising a mixture of a polymer A consisting of polyamide 46 or a copolymer thereof and a polymer B;
b) applying the solution provided in step a) on a first carrier substrate to form a nanofiber layer on said substrate;
c) consolidating the nanofiber layer formed on the substrate.

The membrane manufactured by the method according to the present invention presents a steadier LRV and likewise less reduced channel formation. Additionally, with the method of the present invention, the manufactured membrane has an improved lifetime, which is demonstrated by an LRV decrease of less than 25% after passing through the filter an amount of at least 10000 Liter water/m² at a pressure difference of 0.1 MPa and measured at ambient temperature, i.e. in the present invention at a temperature of 23° C. Another advantage of the method of the invention is that an adhesion measured in a peel force test according to ISO 11339(1993) within the layer of nanofibers could be obtained of more than 0.02 N/mm. In the context of the present invention, polymers A and B as defined herein are thermoplastic polymers selected from polyamides, polyesters, polyarylene sulfides, polyarylene oxides, polysulfones, polyarylates, polyimides, poly(ether ketone)s, polyetherimides, polycarbonates, copolymers of said polymers among each other and/or with other polymers, including thermoplastic elastomers,

Accordingly, one advantage, amongst other advantages, of the method according to the present invention is that the method achieves the manufacture of a layered membrane with improved fiber-fiber adhesion in nanofibrous nonwoven materials (comprising two polymers, one of which may be advantageously a polyamide, more advantageously polyamide 46 or a copolymer thereof). Better fiber-fiber adhesion is achieved by an addition of a polymer B (also designated as hotmelt) followed by high temperature and/or pressure cycle (consolidation can also be lamination). Polymer B added to the polymer A solution advantageously:
mixes homogeneously with the solution;
phase separates from the polymer A upon removal of solvent and form separate domains;
melts at the lamination temperature, which can be chosen below the melting temperature (Tm) of polymer A (so, Tmₕₒₜₘₑₗₜ<Tₗₐₘᵢₙₐₜᵢₒₙ<Tm_{A}).

Additionally, in the membrane manufactured according to the method of the present invention, a separate adhesive layer between the layer of nanofiber and the carrier substrate layer can be omitted.

According to an embodiment of the present invention, the solution in step a) comprises a mixture of polymer A having a melting temperature Tm_{A} and a polymer B having a melting temperature Tm_{B} wherein Tm_{B} is below Tm_{A} by at least 40° C. Polymers A and B can be any polymers having the melting temperatures as described in the present invention, such as polyamides, polyesters, polyarylene sulfides, polyarylene oxides, polysulfones, polyarylates, polyimides, poly(ether ketone)s, polyetherimides, polycarbonates, copolymers of said polymers among each other and/or with other polymers, including thermoplastic elastomers. According to the present invention, the first polymer, polymer A is a polymer, such as a first polyamide, having a molar carbon to nitrogen ratio (C/N) of between 4 and 6, such as PA46 and the second polymer (polymer B) has a C/N ratio of between 6 and 11, such as a second polyamide. In combination with the C/N ratio of polymer B, it results that the lifetime decreases when the C/N ratio of polymer A is more than 6. A molar C/N ratio for polymer A lower than 4 results in polymers with a low thermal stability. With a C/N value above 11, polymer B is not soluble in carboxylic acids, which may be experimentally desired. With a C/N value below 6, the lifetime of the membrane is insufficient. In the context of the present invention, PA46 and/or the copolymer thereof can be considered as the first polymer (polymer A) and polymer B can be considered as the second polymer of the mixture recited in step a). Accordingly, in the context of the present invention, polymer A is PA46 or a copolymer thereof, as this polymer offers a combination of a wide processing window in spinning, temperature/pressure cycle and lifetime.

Polymer B may be a polyamide having a molar carbon to nitrogen ratio (C/N) of between 6 and 11, such as a C/N ratio of 6, 7, 8, 9, 10, or 11. According to a preferred embodiment of the present invention, if a polyamide is used as polymer B, the C/N (carbon to nitrogen) ratio is between 6 and 11. According to an embodiment of the present invention, the second polymer, polymer B, comprises a polymer selected from the group consisting of polyamides, polyesters, polyethylene oxides, copolymers thereof and mixtures thereof. The second polymer can advantageously be a polyamide copolymer such as a copolymer of PA 6 and/or PA 66. Examples include but are not limited to Akulon F130 (DSM, Tm=220° C.), Novamid 2320A (DSM, Tm=218° C.), Novamid 2420A (DSM, Tm=190° C.), Platamid M995 (Arkema, Tm=144° C.), Platamid M1276 (Arkema, Tm=110° C.). Suitable polymer B may be a polyamide or a copolyamide chosen from PA 6/66/610, PA 6/66/69, PA 6/66/12 and polyamides or copolyamides having melting points between 110° C. and 165° C. With the term melting point is herein understood the temperature measured by DSC with a heating rate of 5° C. falling in the melting range and showing the highest melting rate. The melt enthalpy of polymer B is preferably less than 50 J/g applying the method according to ISO 11357-3 (2009). A melt enthalpy of less than 50 J/g is advantageous in step c), in order to the nanofiber layer formed on the substrate (by providing heat to the nanofiber layer, a consolidated structure is obtained). In order to provide a membrane with an even more steadier LRV in function of the amount of water passed through the membrane at a certain pressure the melt index of polymer B measured at 160° C. according to ISO 1133 (160° C./2.16 kg) is between 10 and 70 g/10 min, preferably at least 15 g/10 min and more preferably between 30 and 50 g/10 min.

According to a preferred embodiment of the method of the invention, polymer A and polymer B are suitably present in the solution of step a) in a weight ratio A/B between 50/50 and 95/05, preferably between 60/40 and 80/20, generally in a concentration of between 5 and 25 wt. %, preferably between 10 and 15 wt. %. Reducing the solution concentration can for example reduce the nanofiber diameter. Another possibility to vary the diameter is to modify the process conditions such as for example the applied electrical voltage, the flow rate of the polymer solution, the choice of polymer and/ or the spinning distance. A suitable viscosity is between 200 and 1000 mPa.s. Advantageously, the weight ratio polymer A/polymer B is in the range between 50/50 and 95/05. The polymers A and B can be present in the solution in any weight ratio within the above-mentioned range, or ratios selected form the group 50:50, 55:45, 60:40, 65:35, 70:30, 75:25, 80:20, 85:15, 90:10, 95:5.

According to an embodiment of the present invention, the solution comprises a mixture of a polymer A with a melting point Tm_{A} greater than (above) 200° C., preferably greater than 220° C., more preferably greater than 240° C., most preferably greater than 260° C. and a polymer B having a melting point Tm_{B} which is inferior to Tm_{A} by 40° C. With a temperature difference smaller than 40° C., the retention of the LRV of the membrane is either insufficient or the layer of nanofibers risks to melt during the temperature/pressure cycle in step c) of the method of the invention, thereby destroying the desired permeability of the membrane. Preferably, polymer B has a melting point 40° C. below Tm_{A} (Tm_{B}=Tm_{A}−40° C.), more preferably 100° C. below Tm_{A} (Tm_{B}=Tm_{A}−100° C.), most preferably 150° C. below Tm_{A}(Tm_{B}=Tm_{A}−150° C.). Preferably, the melting point of polymer B is above 125° C., more preferably above 135° C. or even above 145° C. to advance the temperature stability of the membrane.

According to a preferred embodiment of the present invention, the solution comprises a mixture of PA 46 or a copolymer thereof and polymer B in a weight ratio polymer A/polymer B in the range from 50/50 to 95/5, wherein polymer B is a polyamide having a molar C/N ratio in the range from 6 to 11 and has a melting point (or melting temperature) Tm_{B} below the melting temperature of polymer A Tm_{A} by at least 40° C.

In the context according to the present invention, the substrate melting temperature can advantageously be higher than the hotmelt (polymer B) Tₘ. In other words, when the substrate is a single component substrate, then the consolidation (or lamination) temperature (T) can advantageously be lower than Tm of the substrate (Tm_{sub}) and the consolidation temperature is between the melting temperature of polymer B and the melting temperature of the substrate. The melting temperature of polymer A is at least equal to or above the melting temperature of the substrate. Therefore, in the context of this embodiment of the present invention : Tm_{B}<Tm_{Sub} and Tm_{B}<T<Tm_{Sub}, Tm_{A}. In the case the substrate is a bicomponent substrate (having a core with higher melting point Tm_{Core} and a shell with lower Tm_{Shell}), the shell is advantageously to be melt during lamination but the core remains intact. Accordingly, in the context of the present invention, Tm_{Shell}<T<Tm_{core}. Therefore, in the context of the present invention, Tm_{B}, Tm_{Shell}<T<Tm_{Core}, Tm_{A}.

In the context of the present invention, step b) is the step of applying the solution provided in step a) on a first carrier substrate thereby allowing forming at least a first layer of nanofibers on a first carrier substrate. Step b) can be carried out by spinning a solution on one side of the first carrier substrate to form a further structure. Spinning a solution may be done by rotorspinning or electrospinning. Preferably the layer of nanofibers is made by electrospinning. According to an embodiment of the present invention, the nanofiber layer formed in step b) has a thickness in the range 3 to 50 μm. The thickness of step b) is determined by ASTM D-645 (or ISO 534), which method is hereby incorporated by reference, under an applied load of 50 kPa and an anvil surface area of 200 mm². Such a thickness of nanofiber layer provides resistance and good adhesion between the nanofiber layer and the substrate.

According to an embodiment of the present invention, step c) is a consolidation step carried out at a temperature between Tm_{B} and Tm_{A}. When step c) is carried out at a temperature between between Tm_{B} and Tm_{A}, the nanofiber layer is thermally bonded on the substrate. The consolidation step can therefore be a thermally bonding of the nanofiber layer on the substrate. The consolidation step can also be a step where pressure, or pressure and heating is applied. According to an embodiment of the present invention, the further structure is consolidated in step c). The consolidation step can be carried out by means of a temperature cycle and/or pressure cycle at a temperature between Tm_{B} and Tm_{A}. When the consolidation step is carried out between Tm_{B} and Tm_{A}, thermal bonding occurs between the nanofiber layer and the carrier substrate. The temperature cycle and/or pressure cycle generally includes, bringing the further structure up to or above the melting temperature of polymer B and below the melting and degradation temperature of the at least first carrier substrate and of the first layer of nanofibers and reducing the temperature below the softening temperature of the adhesive thus obtaining the membrane. The temperature/pressure cycle could be carried out by calandering the further structure between heated nip rolls at elevated temperature and pressure. The nip rolls can be smooth or with a rough surface and can be used with or without release paper. One or more nip rolls may be heated to a temperature between Tm_{B} and Tm_{A}, preferably at a temperature in the interval Tm_{B} to Tm_{B}+50° C., more preferably at a temperature in the interval Tm_{B} and Tm_{B}+25° C. A good adhesion in the layer of nanofibers was obtained at a temperature of at least Tm_{B}, and preferably at a temperature of Tm_{B}+5° C.

According to a preferred embodiment of the present invention, a step (b-2) can be carried out after step b) and before step c) and comprises applying a second substrate on the nanofiber layer obtained in step b). The method according to the present embodiment of the invention allows the formation of a membrane construction obtaining a layer of nanofibers comprising a mixture of a polymer A consisting of polyamide 46 or a copolymer thereof and polymer B which is located between two layers of carrier substrate. According to an embodiment of the present invention, if a second substrate is provided, the second substrate is advantageously consolidated by thermally bonding to the nanofiber layer. According to the present invention, the first and/or second substrate can comprise a polymer selected from the group consisting of polyester, polyamide, polyolefin, e.g. polyethylene terephthalate (PET), polyamide 6 (PA6), PA66, PA46, polypropylene.

According to an embodiment of the present invention, wherein step b) and/or step b-2) is/are carried out by electrospinning. The method according to the present invention allows providing a better process for manufacturing membrane constructions compared to known methods. Some advantages are that the method according to the present invention is a “one pot” electrospinning process: both polymers are dissolved in the same solution and electrospun simultaneously in one fiber. Further, no further reaction is needed to create bond between fibers: the method according to the present invention carries out the melting of one of the components in the fiber. Furthermore, no core-shell structure is necessary, a morphology with islands in the nanofibers are enough.

According to an embodiment of the present invention, the solution in step a) comprises an organic solvent comprising a carboxylic acid group. According to the present invention, the solution in step a) can comprise at least one carboxylic acid. The carboxylic acid can comprise between 1 and 4 carbon atoms and at least one carboxylic group. According to a preferred embodiment of the present invention, the solution in step a) comprises at least one carboxylic acid selected from the group consisting of formic acid, acetic acid and a combination thereof. According to a more preferred embodiment of the present invention, the solution in step a) comprises a mixture of two carboxylic acids in a weight ratio in the range 1:3 to 3:1, such as any ratio within that range or ratios selected form the group 1:3, 1: 2.5, 1:2, 1: 1.5, 1:1, 1.5:1, 2:1, 2.5:1, 3:1. In the context of the present invention, the solution in step a) may contain one or more suitable solvents. Suitable solvents for polyamides are formic acid, acetic acid, hexafluoropropanol, trifluoroacetic acid, methanol, ethanol, isopropanol and chloroform. Preferably polymer A and polymer B are dissolved in a solvent comprising acetic acid or formic acid or a mixture thereof.

In the method of the invention, the first layer of nanofibers may be provided with a second carrier substrate at a side of the first layer of nanofibers opposite to the first carrier substrate prior to step c). An advantage of a second or even additional carrier substrate could be to protect the first layer of nanofibers during the membrane fabrication process, especially during the consolidation step (step c)) and in particular where a pressure cycle is used for consolidating the further structure. A further advantage of a first nanofiber layer between two carrier substrate layers is to prevent the first nanofiber layer from surface induced damages (wear) and to reduce the stress applied by a liquid flow on the nanofiber membrane. It is understood that the membrane may be provided with further layers of nanofibers, e.g. with a different fiber diameter and/or porosity.

The present invention further relates to a layered polymer A/polymer B membrane construction comprises at least a first carrier substrate and at least a first layer of nanofibers on one side of the first carrier substrate, wherein the nanofibers comprise a mixture of a polymer A consisting of polymer A with a melting point Tm_{A} of at least 200° C. and a polymer B having a melting point Tm_{B} inferior to Tm_{A} by at least 40° C. (Tm_{B} is 40° C. below Tm_{A}), in a weight ratio A/B in the range from 50/50 to 95/05 and that the Log Reduction Value of the membrane construction for a Klebsiella terrigena suspension in sterile water is less than 25% after passing through said membrane construction at least an amount of 10,000 liter of Milli-Q water/m² at a pressure difference over the membrane construction of 0.1 MPa. In an embodiment of the present invention, the layered polyamide 46 membrane construction comprising a nanofiber layer of a first polymer (polymer A) and a second polymer (polymer B) on a first substrate wherein the nanofiber layer and the substrate layer are consolidated by thermal bonding. In the context of the present invention, the nanofiber layer comprises mixture of a polymer A consisting of polyamide 46 or a copolymer thereof. In particular, the membrane construction according to the present invention is a fibrous nonwoven membrane construction, which can be used for removing microorganisms from liquid samples. Milli-Q water is to be understood as ultrapure water as defined by standard ISO 3696. Ultra-pure water is obtained by purification of water involving successive steps of filtration and deionization to achieve a purity expediently characterised in terms of resistivity: 18-19 MΩ·cm at 25° C., typically 18.2 MΩ·cm at 25° C. Advantageously, the weight ratio polymer A/polymer B is in the range from 60/40 to 80/20, generally applied as a solution having in a concentration of the polymer A/polymer B mixture of between 5 and 25 wt. %, preferably between 10 and 15 wt. %. Reducing the solution concentration can for example reduce the nanofiber diameter. Another possibility to vary the diameter is to modify the process conditions such as for example the applied electrical voltage, the flow rate of the polymer solution, the choice of polymer and/ or the spinning distance. A typical base weight of the layer of nano-fibers for a membrane construction suitable for microfiltration is between 1 and 5 g/m². A preferred base weight of the layer of nano-fibers is between 2 and 5 g/m².

Another aspect of the present invention recites a membrane construction comprising at least a first carrier substrate and at least a first layer of nanofibers on one side of the first carrier substrate, characterized in that the nanofibers comprise a mixture of a polyamide A with a melting point TmA greater than 10 and a polyamide B with a melting point TmB less than TmA−40° C., in a weight ratio A/B between 50/50 and 95/05 and that the adhesion measured according to ISO 11339 within the first layer of nanofibers is more than 0.005 N/mm.

Yet another aspect of the present invention relates to a membrane construction comprising polyamide 46 or a copolymer thereof obtainable by the method according to the present invention. The present invention further relates to a membrane construction comprising at least a first carrier substrate and at least a first layer of nanofibers on one side of the first carrier substrate, when the nanofibers comprise a mixture of a polymer A with a melting point Tm_{A} greater than 200° C., such as polyamide 46 or a copolymer thereof and a polymer B with a melting point Tm_{B} less than Tm_{A}−40° C., in a weight that the adhesion measured according to ISO 11339 within the first layer of nanofibers is more than 0.005 N/mm. Adhesion values of more than 0.005 N/mm indicate fiber-fiber adhesion within the layer of nano-fibers. Preferably the adhesion measured in a peel force test according to ISO 11339 is more than 0.02 N/mm, preferably more than 0.04 N/mm and most preferably more than 0.06 N/mm. According to a different aspect of the present invention, a membrane construction comprising a polyamide can also be obtainable by the method according to the present invention and results in a membrane construction comprising at least a first carrier substrate and at least a first layer of nanofibers on one side of the first carrier substrate, the nanofibers comprising a mixture of a polymer A with a melting point Tm_{A} and a polymer B with a melting point Tm_{B} below Tm_{A} by at least 40° C.

According to an embodiment of the present invention, the membrane construction may comprise a second carrier substrate. In this embodiment, the nanofiber layer and both carrier substrates are consolidated by thermal bonding. According to the present invention, the membrane construction can be used in filtering devices. A method for filtering air or water, thereby removing particulate or microorganisms in air or water, accordingly comprises introducing air or water respectively, into the filtering device comprising the membrane construction according to the present invention.

The preferences and definitions specified for the method according to the present invention also applies to the membrane according to the present invention and to a filtering device comprising the membrane obtainable by the method according to the present invention.

As used herein, the term “electrospinning” (or electro-spinning) refers to a technology that produces nano-sized fibers referred to as electro-spun fibers from a solution using interactions between fluid dynamics and charged surfaces. In electro-spinning, a polymer solution or melt provided from one or more needles, slots or other orifices is charged to a high voltage relative to a collection grid. Electrical forces overcome surface tension and cause a fine jet of the polymer solution or melt to move towards the grounded or oppositely charged collection grid. The jet can splay into even finer fiber streams before reaching the target and is collected as an interconnected web of small fibers. The dried or solidified fibers can have number average diameters of about 10 to 1000 nm, or from about 70 to about 200 nm, although 100 to 600 nm fibers are commonly observed. Various forms of electro-spun nanofibers include branched nanofibers, split nanofibers, nanofiber yarns, surface-coated nanofibers, nanofibers produced in a vacuum, and so forth. The production of electro-spun fibers is illustrated in many publication and patents, including, for example, P. W. Gibson et al, “Electro-spun Fiber Mats: Transport Properties,” AIChE Journal, 45(1): 190-195 (January 1999).

As used herein, the term “carrier substrate” refers to a substrate that allows normal manual manipulation without damaging or breaking. The carrier substrate, generally made of microfibers, may be adapted for carrying a layer to remain undamaged during manipulation, or use. The surface weight of a carrier substrate is generally in the range from (and including) 10 to (and including) 300 g/m², preferably in the range from 20 (and including) to (and including) 200 g/m² and more preferably in the range from (and including) 30 to (and including) 100 g/m².

The carrier substrate is not limited to fiber-type substrates (i.e. non-woven). It can be any textile, woven, knitted or in any other form. It can also be any porous membranes including ceramics, foams and films like precipitated, quenched or stretched films. In case of ceramics, the substrate weight can be much more than 5000 g/m². The carrier substrate can be a polymer, such as a polymer chosen from polyester, polyamide, polyolefin.

As used herein, the term “microfibers” refers to small diameter fibers generally having an average diameter from about 0.5 μm to about 100 μm, with an exemplary range from about 4 to about 50 μm. Examples of microfibers include, but are not limited to, melt-blown fibers, spun-bonded fibers, paper-making fibers, pulp fibers, fluff, cellulose fibers, nylon staple fibers, although such materials can also be made larger in size than microfiber-sized. Microfibers can further include ultra-microfibers, i.e., synthetic fibers having a denier per filament (dpf) of between about 0.5 and about 1.5, provided that the fiber diameter is at least about 0.5 μm. Microfibers may be made of glass, carbon, ceramics, metals, and synthetic polymers, e.g. polyamides, polyesters, polyolefins, or natural polymers like cellulose and silk.

As used herein, the term “nanofibers” refers to fibers having a number average diameter generally not above 1000 nanometers (nm), preferably in the context of the present invention, the number average diameter of the nanofibers is not above 800 nm, more preferably not above 600 nm. In the context of the present invention, the nanofibers have a number average diameter range from about 40 to about 600 nm, advantageously from about 40 to about 300 nm, more advantageously from about 60 to about 100 nm. Other exemplary ranges include from about 300 to about 600 nm, from about 100 to 300 nm, or about 40 to about 200 nm. To determine the number average diameter of the fibers, ten scanning electron microscopy (SEM) images at 5,000× magnification were taken of each nanofiber sample or web layer thereof. The diameter of ten clearly distinguishable nanofibers was measured from each photograph and recorded, resulting in a total of one hundred (100) individual measurements. Defects were not included (i.e. lumps of nanofibers, polymer drops, intersections of nanofibers). The number average diameter of the fibers can be calculated from one hundred (100) individual measurements.

### EXAMPLES

The thermal behaviour and characteristics such as enthalpy and the melting temperature of the polymers were studied by conventional differential scanning calorimetry (DSC) applying the method according to ISO 11357-3 (2009). For the measurements a standard heat flux Mettler-Toledo DSC 823 was used and the following conditions applied. Samples of approximately 3 to 10 mg mass were weighed with a precision balance and encapsulated in (crimped) 40 μl aluminium crucibles of known mass. The aluminium crucible was sealed with a perforated aluminium crucible lid. Base Weight was determined by ASTM D-3776, and reported in g/m². Porosity (P) was calculated by dividing the base weight of the sample in g/m² by the product of polymer density in g/cm³ and the sample thickness in micrometers, subtracting the resulting number from 1, and multiplying the result by 100, according to the following formula: P=100(1−baseweight/(density.thickness)). Fiber Diameter was determined as follows. Ten scanning electron microscope (SEM) images at 5000 times magnification were taken of each nanofiber layer sample. The diameters of ten (10) clearly distinguishable nanofibers were measured from each SEM image and recorded. Defects were not included (i.e., lumps of nanofibers, polymer drops, intersections of nanofibers). The average fiber diameter for each sample was calculated. Thickness was determined by ASTM D 1777-64, and is reported in micrometers.

### Materials

A Stanyl®, which is commercially available from DSM, the Netherlands was used as polymer A
Platamid M995 (Arkema) was used as polymer B
CCL30=PET from Nam Yang Nonwoven Fabrics is used as a bi-component nonwoven polyester support layer with a base weight of 30 g/m².
Fomic acid 98-100% Proanalyse from Merck was used as solvent.
Milli-Q water is ultrapure water from Merck Millipore.

### LRV Test Method

Log Reduction Value of the membrane construction was measured with a membrane disc with a diameter of 40 mm and a 100 mL Klebsiella terrigena suspension in sterile water with bacteria concentration of more than 5*10⁹ CFU/L, generally between 5 and 7*10⁹ CFU/L. The pressure drop over the membrane construction was 0.05 MPa, controlled by a nitrogen pressure on the influent vessel. 10 mL of the effluent was collected and incubated for counting the CFU. The LRV was calculated according to formula (1).

### Aging Test Method

LRV of a membrane construction was measured at a 0.05 MPa pressure drop as described above. 13 L Milli-Q water (corresponding to more than 10,000 L/m² was pushed through the filter in backflush with a pressure of 0.1 MPa, after which the LRV was measured again. Peel tests of the values reported in this application was carried out according ISO 11339 on samples consisting of three layers, the middle layer being the layer of nanofibers. Samples were in all cases 20 mm wide and T-shaped. Crosshead speed was 100 mm/min. The average force/mm width was determined over a sample length of 200 mm.

### Example I (according to the present invention)

A layer of nanofibers with a base weight of 2 g/m² was prepared using a 15 wt. % solution of PA46 (DSM) and Platamid M995 (Arkema) in a 70/30 weight ratio in formic acid. This layer was calandered between two nonwoven polyester support layers, using a nip roll distance of 150 μm at a temperature of 145° C.
   Mechanical properties in terms of the adhesion strength is improved significantly, as demonstrated by a peel force measured according to adhesion measured in a peel force test according to ISO 11339 (Samples consisted of three layers, the middle layer being the layer of nanofibers and the two others being carrier substrate. Samples were in all cases 20 mm wide and T-shaped. Crosshead speed was 100 mm/min. The average force/mm width was determined over a sample length of 200 mm).
   Aging properties in bacteria retention has improved. A quantitative measure of microorganism retention by a filtration membrane is customarily expressed as a Log Reduction Value, or LRV. LRV is the logarithm of the ratio of the Colony Forming Units (CFU) concentration in the membrane influent solution to that in the membrane effluent solution: LRV=Log{[CFU]_{influent}/[CFU]_{effluent}}
LRV values (bacteria: Klebsiella terrigena, [CFU]_{influent}=5.10⁹ CFU/L) were measured at room temperature before filtering on a 40 mm filter disc. Then 13 L Milli-Q water (corresponding to more than 10,000 L/m²) was pushed through the filter with a pressure of 0.1 MPa, after which the LRV was measured again. The LRV decreased from 8 to 6.

### Example II (according to the present invention)

A layer of nanofibers with a base weight of 2 g/m² was prepared by electrospinning of a 30% (w/w) polymer solution of a ratio 70% PET and 30% PES-120L in a solutions in a mixture of trifluoracetic acid (TFA) and dichloromethane (DCM) (80:20 v/v), following the conditions reported in Example I. This layer was calandered between two nonwoven polyester support layers, using a nip roll distance of 150 μm at a temperature of 145° C.
   Mechanical properties in terms of the adhesion strength is improved significantly, as demonstrated by a peel force measured according to adhesion measured in a peel force test according to ISO 11339 (Samples consisted of three layers, the middle layer being the layer of nanofibers and the two others being carrier substrate. Samples were in all cases 20 mm wide and T-shaped. Crosshead speed was 100 mm/min. The average force/mm width was determined over a sample length of 200 mm).
   Aging properties in bacteria retention has improved. A quantitative measure of microorganism retention by a filtration membrane is customarily expressed as a Log Reduction Value, or LRV. LRV is the logarithm of the ratio of the Colony Forming Units (CFU) concentration in the membrane influent solution to that in the membrane effluent solution: LRV=Log{[CFU]_{influent}/[CFU]_{effluent}}
LRV values (bacteria: Klebsiella terrigena, [CFU]_{influent}=5.10⁹ CFU/L) were measured at room temperature before filtering on a 40 mm filter disc. Then 13 L Milli-Q water (corresponding to more than 10,000 L/m²) was pushed through the filter with a pressure of 0.1 MPa, after which the LRV was measured again. The LRV decreased from 8 to 6.

### Comparative Experiment A (illustrating performance prior art)

The layer of nanofibers was prepared using a 15 wt % solution of PA46 in formic acid using electrospinning. It was thermobonded by means of a polyamide based hotmelt nonwoven fabric between two non-woven polyester support layers.
   Peel test showed adhesion of 0.05 N/mm or below.
LRV values were measured after 0 and 10000 liter of Milli-Q water/m² at a pressure difference over the membrane construction of 0.1 MPa. The LRV decreased from 8 to 3.

1. Method for the manufacture of a layered membrane construction comprising:
a) providing a solution comprising a mixture of a polymer A and a polymer B in a weight ratio A/B between 50/50 and 95/05, polymer A having a melting temperature Tm_{A} and a polymer B having a melting temperature Tm_{B} wherein Tm_{B} is below Tm_{A} by at least 40° C.;
b) applying the solution provided in step a) on a first carrier substrate to form a nanofiber layer on said substrate;
c) consolidating the nanofiber layer formed on the substrate by thermal bonding at a temperature between Tm_{B} and Tm_{A} by means of a temperature and/or pressure cycle thus obtaining the membrane.

2. Method according to claim 1, wherein polymer B comprises a polymer selected from the group consisting of polyamide, polyethylene oxide, copolymers thereof and mixture thereof.

3. Method according to claim 1, wherein polymer B is a polyamide having a molar carbon to nitrogen ratio (C/N) of between 6 and 11.

4. Method according to claim 1, wherein the polyamide A has a molar carbon to nitrogen ratio (C/N) of between 4 and 6.

5. Method according to claim 1, wherein a step (b-2) is carried out after step b) and before step c) and comprises applying a second carrier substrate on the nanofiber layer obtained in step b).

6. Method according to claim 1, wherein step b) is carried out by electrospinning.

7. Method according to claim 1, wherein the layer formed in step b) has a thickness in the range of 3 to 50 μm measured according to standard ASTM D-645.

8. Method according to claim 1, wherein the solution comprises at least one carboxylic acid.

9. Method according to claim 8, wherein the solution comprises at least one carboxylic acid selected from the group consisting of formic acid, acetic acid and a combination thereof.

10. Method according to claim 8, wherein the solution comprises a mixture of two carboxylic acids in a weight ratio in the range from 1:3 to 3:1.

11. Method according to claim 5, wherein the first and/or second substrate comprise a polymer selected from the group consisting of polyester, polymer and polyolefin.

12. Membrane construction comprising at least a first carrier substrate and at least a first layer of nanofibers on one side of the first carrier substrate, characterized in that the nanofibers comprise a mixture of a polyamide A with a melting point TmA greater than 10 and a polyamide B with a melting point TmB less than TmA−40° C., in a weight ratio A/B between 50/50 and 95/05 and that the adhesion measured according to ISO 11339 within the first layer of nanofibers is more than 0.005 N/mm.

13. Layered polyamide 46 membrane construction comprising a nanofiber layer of polyamide 46 or a copolymer thereof and a second polymer on a first substrate wherein the nanofiber layer and the substrate layer are consolidated by thermal bonding.

14. Membrane construction according to claim 13, wherein the membrane construction comprises a second substrate and wherein the nanofiber and both substrate layers are consolidated by thermal bonding.

15. Filtering device comprising the membrane construction according to claim 13.
